(19) United States
(12) Patent Application Publication
(10) Pub. No.: US 2018/0190440 A1
(43) Pub. Date: Jul. 5, 2018

(54) ELECTRIC DOUBLE LAYER CAPACITOR AND MANUFACTURING METHOD THEREFOR

(71) Applicant: Murata Manufacturing Co., Ltd., Nagaokakyo-shi (JP)

(72) Inventors: Keiji Horikawa, Nagaokakyo-shi (JP); lwao Kurimoto, Nagaokakyo-shi (JP); Keisuke Nakano, Nagaokakyo-shi (JP)

(21) Appl. No.: 15/908,935

(22) Filed: Mar. 1, 2018

Related U.S. Application Data
(63) Continuation of application No. PCT/JP2016/076832, filed on Sep. 12, 2016.

(30) Foreign Application Priority Data
Sep. 17, 2015 (JP) 2015-183985

(51) Int. Cl. H01G 11/52; H01G 11/12; H01G 11/86; H01G 11/26; H01G 9/00

(52) U.S. Cl. CPC H01G 11/52; H01G 11/12; H01G 11/54; H01G 11/26; H01G 9/155; H01G 11/86

(57) ABSTRACT

An electric double layer capacitor that includes a first electrode having a first polarizable electrode on a first collector electrode; a second electrode having a second polarizable electrode on a second collector electrode; and a separator interposed between the first polarizable electrode and the second polarizable electrode. The separator includes a bonding part filled with a resin. The bonding part extends to a surface of the separator closer to the first polarizable electrode, and the separator and the first polarizable electrode are bonded to each other by the bonding part.

### CROSS REFERENCE TO RELATED APPLICATIONS

The present application is a continuation of International application No. PCT/JP2016/076832, filed Sep. 12, 2016, which claims priority to Japanese Patent Application No. 2015-183985, filed Sep. 17, 2015, the entire contents of each of which are incorporated herein by reference.

### FIELD OF THE INVENTION

The present invention relates to an electric double layer capacitor and a manufacturing method therefor.

### BACKGROUND OF THE INVENTION

Conventionally, capacitors are widely used in various electronic devices such as mobile phones. Electric double layer capacitors (EDLC) are a known type of capacitor. Electric double layer capacitors have no chemical reaction upon charging and discharging, unlike secondary batteries, and thus have advantages such as having a long product life and being able to charge/discharge a large current in a short period of time. Accordingly, attempts have been made to apply electric double layer capacitors to intended uses which require a long product life, intended uses which require a large current, and the like.

For example, Patent Document 1 mentions an example of an electric double layer capacitor. For the electric double layer capacitor described in Patent Document 1, an electrode and a separator are integrated by applying an adhesive to the protruded surface of an electrode end and attaching a separator to that part.

Patent Document 1: Japanese Patent Application Laid-Open No. 2007-299855

### SUMMARY OF THE INVENTION

When the separator is attached after applying the adhesive onto the electrode, an adhesive layer is formed between the electrode and the separator. Therefore, the electric double layer capacitor described in Patent Document 1 has an adhesive layer that bonds the electrode and the separator. For this reason, due to the presence of the adhesive layer, the electric double layer capacitor described in Patent Document 1 has a problem of difficulty reducing thickness.

A main object of the present invention is to provide a thin electric double layer capacitor.

An electric double layer capacitor according to the present invention includes a first electrode, a second electrode, and a separator. The first electrode has a first collector electrode and a first polarizable electrode. The first polarizable electrode is provided on the first collector electrode. The second electrode has a second collector electrode and a second polarizable electrode. The second polarizable electrode is provided on the second collector electrode. The separator is interposed between the first polarizable electrode and the second polarizable electrode. The separator is impregnated with an electrolyte. The separator is provided with a bonding part filled with a resin. The bonding part extends to a surface of the separator closer to the first polarizable electrode.

The separator and the first polarizable electrode are bonded to each other by the bonding part. In the electric double layer capacitor according to the present invention, the separator and the first polarizable electrode are bonded to each other by the bonding part composed of the resin filling the separator. For this reason, the gap can be reduced between the separator and the polarizable electrode, for example, as compared with a case of bonding the separator and the polarizable electrode with an adhesive layer provided between the separator and the polarizable electrode. Therefore, the thickness of the electric double layer capacitor can be reduced.

In the electric double layer capacitor according to the present invention, the separator and the first polarizable electrode preferably make contact with each other in a region provided with the bonding part. In this case, the thickness of the electric double layer capacitor can be further reduced.

In the electric double layer capacitor according to the present invention, the bonding part preferably extends to the surface closer to the second polarizable electrode, and the separator and the second polarizable electrode are bonded by the bonding part. In this case, it is not always necessary to provide an adhesive layer between the separator and the second polarizable electrode, and the thickness of the electric double layer capacitor can be reduced.

In the electric double layer capacitor according to the present invention, the entire surface of the separator closer to the first polarizable electrode preferably makes contact with the first polarizable electrode. In this case, the thickness of the electric double layer capacitor can be further reduced.

In the electric double layer capacitor according to the present invention, the bonding part preferably does not extend to the first collector electrode. In this case, the flow of the electrolyte, gas, or the like is less likely to be blocked by the bonding part, and the electric characteristics of the electric double layer capacitor is thus less likely to be deteriorated.

In the electric double layer capacitor according to the present invention, the first electrode has an opposed part that is opposed to the second electrode in the thickness direction, and a non-opposed part that is not opposed to the second electrode in the thickness direction, and the bonding part preferably bonds the non-opposed part and the separator to each other. In this case, the area of the opposed part which functions as a capacitor can be further increased, for example, as compared with a case of bonding the opposed part and the separator by the bonding part. Therefore, the capacitance of the electric double layer capacitor can be prevented from being decreased. In addition, the internal resistance of the electric double layer capacitor can be reduced.

In the electric double layer capacitor according to the present invention, the first electrode has an opposed part that is opposed to the second electrode in the thickness direction, and a non-opposed part that is not opposed to the second electrode in the thickness direction, and the bonding part is preferably provided to have an overlap with a central part of the opposed part. In this case, the gap between the first electrode and the second electrode is less likely to be increased. Therefore, the capacitance can be prevented from being decreased due to the increase in the gap between the first electrode and the second electrode. In addition, the internal resistance of the electric double layer capacitor is less likely to be increased.

In the electric double layer capacitor according to the present invention, the first electrode has an opposed part that is opposed to the second electrode in the thickness direction, and an extended part that is extended from the opposed part, and the opposed part has a rectangular shape with first and second sides extending in a first direction and third and fourth sides extending in a second direction perpendicular to the first direction, the extended part is extended from a part on one side with respect to the center of the opposed part in the second direction, and as viewed from the thickness direction, the bonding part is preferably provided such that at least a part of the bonding part has an overlap with a part located on the other side in the second direction with respect to the center of the opposed part in the second direction. In this case, the gap between the first electrode and the second electrode can be prevented in a more effective manner from being increased. Therefore, the capacitance can be prevented in a more effective manner from being decreased due to the increase in the gap between the first electrode and the second electrode. In addition, the internal resistance of the electric double layer capacitor can be prevented in a more effective manner from being increased.

In the electric double layer capacitor according to the present invention, the extended part is extended from a part on one side with respect to the center of the opposed part in the second direction and on one side with respect to the center thereof in the first direction, and as viewed from the thickness direction, the bonding part is preferably provided such that at least a part of the bonding part has an overlap with a part located on the other side in the second direction with respect to the center of the opposed part in the second direction and on the other side in the first direction with respect to the center thereof in the first direction. In this case, the gap between the first electrode and the second electrode can be prevented in a further effective manner from being increased. Therefore, the capacitance can be prevented in a further effective manner from being decreased due to the increase in the gap between the first electrode and the second electrode. In addition, the internal resistance of the electric double layer capacitor can be prevented in a further effective manner from being increased.

In the method for manufacturing the electric double layer capacitor according to the present invention, it is preferable to form the bonding part by impregnating the separator with an adhesive including a resin, after stacking the separator on the first polarizable electrode. The foregoing method can manufacture an electric double layer capacitor with the separator and the first polarizable electrode in contact with each other. In other words, an electric double layer capacitor can be manufactured, where there is substantially no gap between the separator and the first polarizable electrode. Therefore, high-capacitance electric double layer capacitors can be manufactured.

According to the present invention, a thin electric double layer capacitor can be provided.

### BRIEF EXPLANATION OF THE DRAWINGS

FIG. 1 is a schematic cross-sectional view of an electric double layer capacitor according to a first embodiment.

FIG. 2 is a schematic plan view of a main part of the electric double layer capacitor according to the first embodiment.

FIG. 3 is a schematic cross-sectional view of the electric double layer capacitor according to the first embodiment.

FIG. 4 is a schematic plan view of a first electrode according to the first embodiment.

FIG. 5 is a schematic plan view of a second electrode according to the first embodiment.

FIG. 6 is a schematic cross-sectional view illustrating a process for manufacturing the electric double layer capacitor according to the first embodiment.

FIG. 7 is a schematic cross-sectional view illustrating the process for manufacturing the electric double layer capacitor according to the first embodiment.

FIG. 8 is a schematic cross-sectional view illustrating the process for manufacturing the electric double layer capacitor according to the first embodiment.

FIG. 9 is a schematic cross-sectional view illustrating the process for manufacturing the electric double layer capacitor according to the first embodiment.

FIG. 10 is a schematic cross-sectional view illustrating the process for manufacturing the electric double layer capacitor according to the first embodiment.

FIG. 11 is a schematic cross-sectional view illustrating the process for manufacturing the electric double layer capacitor according to the first embodiment.

FIG. 12 is a schematic cross-sectional view of an electric double layer capacitor according to a second embodiment.

FIG. 13 is a schematic plan view of a main part of the electric double layer capacitor according to the second embodiment.

FIG. 14 is a schematic plan view of an electric double layer capacitor according to a third embodiment.

FIG. 15 is a schematic cross-sectional view of a main part of the electric double layer capacitor according to the third embodiment.

FIG. 16 is a schematic plan view of a first electrode according to the third embodiment.

FIG. 17 is a schematic plan view of a second electrode according to the third embodiment.

### DETAILED DESCRIPTION OF THE INVENTION

An example of a preferred embodiment of the present invention will be described below. However, the following embodiment is considered by way of example only. The present invention is not limited to the following embodiment in any way.

The drawings referenced in the embodiment and the like are schematically made. The ratios between the dimensions of objects drawn in the drawings, and the like may, in some cases, differ from the ratios between the dimensions of actual objects, or the like. The dimensional ratios of objects, and the like may differ between the drawings as well in some cases. The specific dimensional ratios of objects, and the like should be determined in view of the following description.

### First Embodiment

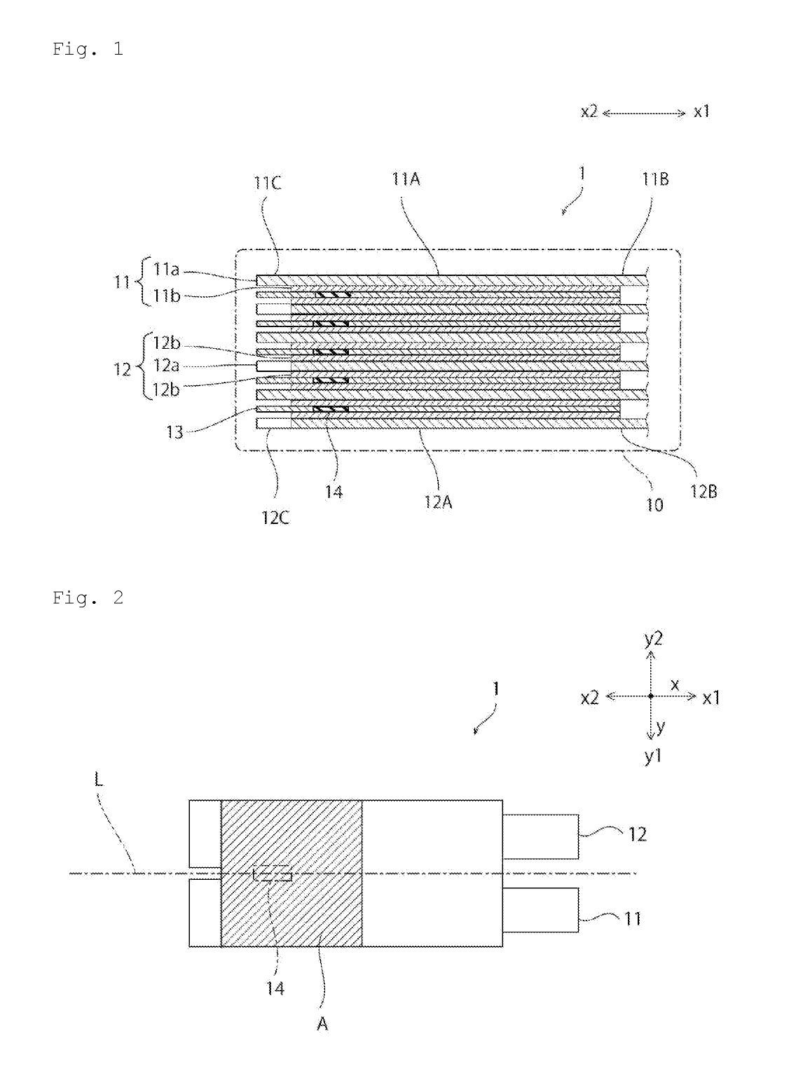

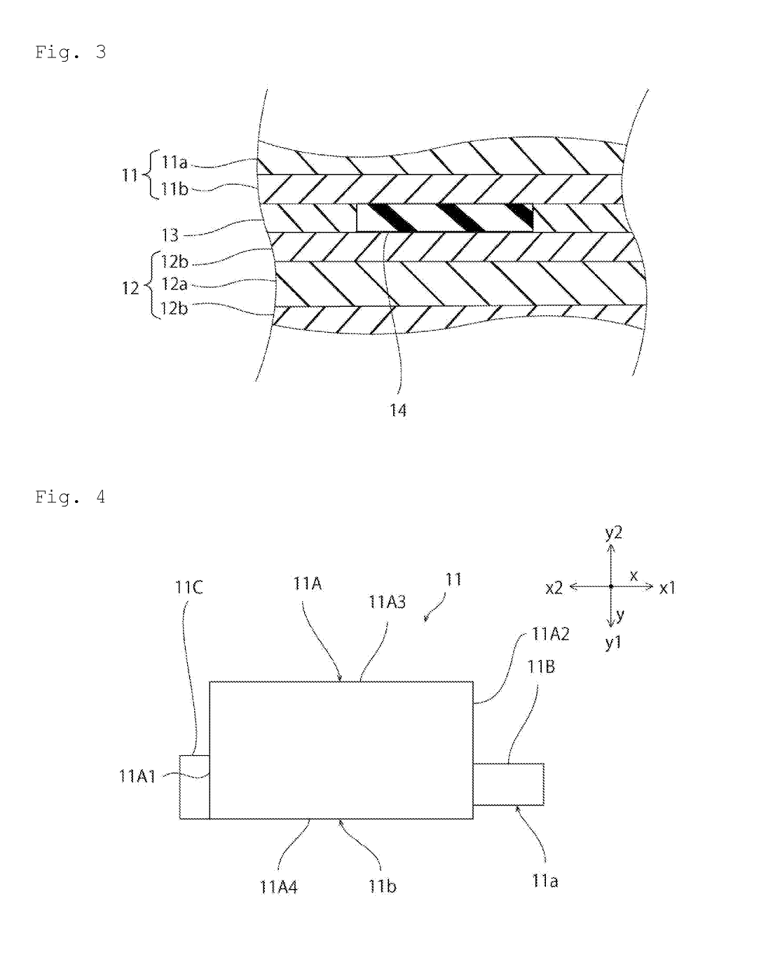

FIG. 1 is a schematic cross-sectional view of an electric double layer capacitor according to the present embodiment. FIG. 2 is a schematic plan view of a main part of the electric double layer capacitor according to the present embodiment. In FIG. 2, the illustration of an exterior body 10 and a separator 13 is omitted.

As shown in FIG. 1, the electric double layer capacitor 1 includes a first electrode 11, a second electrode 12, a separator 13, a bonding part 14, and the exterior body 10.

The first electrode 11 and the second electrode 12 are opposed to each other with the separator 13 interposed therebetween. Specifically, a plurality of first electrodes 11 and a plurality of second electrodes 12 are alternately stacked with separators 13 interposed therebetween. The respective first electrodes 11 are electrically connected by a first extension terminal (not shown), and extended to the exterior body 10. The respective second electrodes 12 are electrically connected by a second extension terminal (not shown), and extended to the exterior body 10.

(First Electrode 11)

The first electrode 11 includes a first collector electrode 11a. The first collector electrode 11a can be made of, for example, aluminum foil or the like. The thickness of the first collector electrode 11a can be, for example, about 10 μm or more and 30 μm or less.

On the first collector electrode 11a, a first polarizable electrode 11b is provided. Specifically, among the second electrodes 12 and the first electrodes 11, the first collector electrode 11a located outermost in the thickness direction (lamination direction) has the first polarizable electrodes 11b provided only on the inner principal surface, and no first polarizable electrodes 11b provided on the outer principal surface. In the case of the other first electrodes 11, the first polarizable electrode 11b is provided on both principal surfaces of the first collector electrodes 11a. In other words, the first polarizable electrode 11b is provided, among the principal surfaces of the first collector electrodes 11a, only on the principal surfaces opposed to the second electrodes 12. The thickness of the first polarizable electrode 11b can be, for example, about 10 μm or more and 30 μm or less.

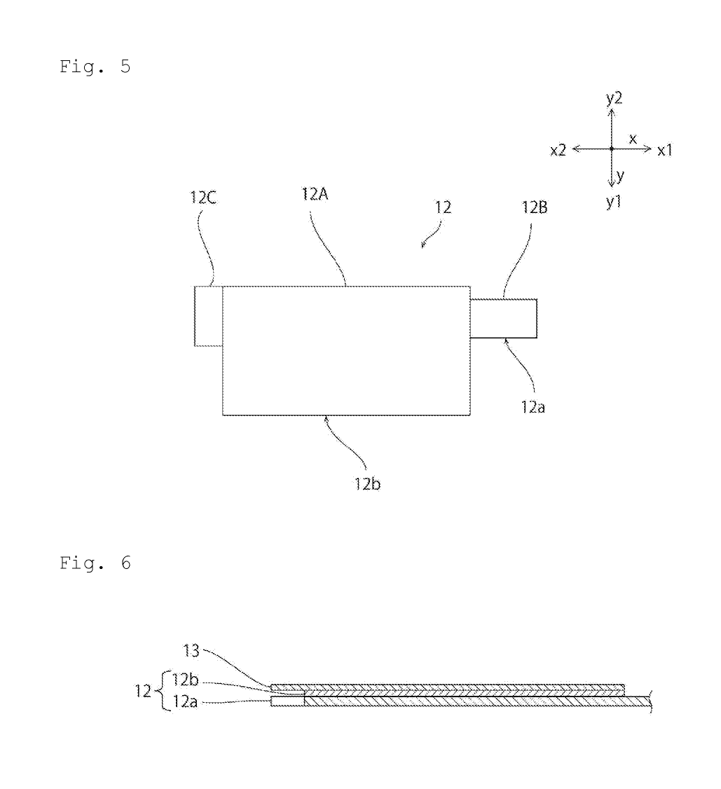

As shown in FIG. 1 and FIG. 4, the first electrode 11 has a rectangular opposed part 11A, an extended part 11B, and a non-opposed part 11C. The opposed part 11A is opposed to the second electrode 12. As shown in FIG. 4, the opposed part 11A has a first side 11A1 and a second side 11A2 extending in the y-axis direction (first direction). The opposed part 11A has a third side 11A3 and a fourth side 11A4 extending along the x-axis direction (second direction). More specifically, the y-axis direction which is the first direction is a direction along the first and second sides 11A1 and 11A2 which are short sides. The x-axis direction which is the second direction is a direction along the third and fourth sides 11A3, 11A4 which are long sides.

The extended part 11B is connected to the opposed part 11A. Specifically, according to the present embodiment, the extended part 11B extends from a part of the opposed part 11A on the y1 side in the y-axis direction perpendicular to the x-axis direction, to the x1 side. The non-opposed part 11C is connected to the opposed part 11A. The non-opposed part 11C extends from the opposed part 11A to the x2 side in the x-axis direction. The non-opposed part 11C extends from a part of the opposed part 11A on the y2 side in the y-axis direction, to the x2 side. The first polarizable electrode 11b is provided only at the opposed part 11A, and not provided at the extended part 11B or the non-opposed part 11C. The extended part 11B and the non-extended part 11C are composed of the first collector electrode 11a.

According to the present embodiment, the plurality of extended parts 11B is, for example, fixed by being integrated with, for example, a solder or the like. However, the plurality of extended parts 11B may be fixed by being connected to a first extension terminal, not shown, without being integrated.

It is to be noted that according to the present embodiment, an example of providing the non-opposed part 11C has been described, but the present invention is not limited to this configuration. For example, the first electrode may be composed of an opposed part and an extended part.

(Second Electrode 12)

As shown in FIG. 1, the second electrode 12 includes a second collector electrode 12a. The second collector electrode 12a can be made of, for example, aluminum foil or the like. The thickness of the second collector electrode 12a can be, for example, about 10 μm or more and 30 μm or less.

On the second collector electrode 12a, a second polarizable electrode 12b is provided. Specifically, among the second electrodes 12 and the first electrodes 11, the second collector electrode 12a located outermost in the thickness direction (lamination direction) has the second polarizable electrodes 12b provided only on the inner principal surface, and no second polarizable electrodes 12b provided on the outer principal surface. In the case of the other second electrodes 12, the second polarizable electrode 12b is provided on both principal surfaces of the second collector electrodes 12a. In other words, the second polarizable electrode 12b is provided, among the principal surfaces of the second collector electrodes 12a, only on the principal surfaces opposed to the first electrodes 11. The thickness of the second polarizable electrode 12b can be, for example, about 10 μm or more and 30 μm or less.

As shown in FIG. 1 and FIG. 5, the second electrode 12 has a rectangular opposed part 12A, an extended part 12B, and a non-opposed part 12C. The opposed part 12A is opposed to the first electrode 11. The extended part 12B is connected to the opposed part 12A. Specifically, according to the present embodiment, the extended part 12B extends from a part of the opposed part 12A on the y2 side in the y-axis direction, to the x1 side. The non-opposed part 12C is connected to the opposed part 12A. The non-opposed part 12C extends from the opposed part 12A to the x2 side in the x-axis direction. Specifically, according to the present embodiment, the non-opposed part 12C extends from a part of the opposed part 12A on the y1 side in the y-axis direction, to the x2 side. The second polarizable electrode 12b is provided only at the opposed part 12A, and not provided at the extended part 12B or the non-opposed part 12C. The extended part 12B and the non-extended part 12C are composed of the second collector electrode 12a.

According to the present embodiment, the plurality of extended parts 12B is, for example, fixed by being integrated with, for example, a solder or the like. However, the plurality of extended parts 12B may be fixed by being connected to a second extension terminal, not shown, without being integrated.

It is to be noted that according to the present embodiment, an example of providing the non-opposed part 12C has been described, but the present invention is not limited to this configuration. For example, the second electrode may be composed of an opposed part and an extended part.

In addition, the first electrode 11 and the second electrode 12 may have the same size or different sizes.

(Separator 13)

The separator 13 is interposed between the first electrode 11 and second electrode 12 adjacent to each other. The separator 13 has substantially the same shape as the first electrode 11 and the second electrode 12, or has a larger flat plate shape than the first electrode 11 and the second electrode 12. The separator 13 separates the first electrode 11 and the second electrode 12 from each other. The separator 13 can be composed of, for example, a porous sheet with a plurality of open cells.

(Exterior Body 10)

The first electrodes 11, the second electrodes 12, and the separators 13 are housed in the exterior body 10. The first electrodes 11 are connected to a first extension terminal (not shown) provided outside the exterior body 10. The second electrodes 12 are connected to a second extension terminal (not shown) provided outside the exterior body 10. The exterior body 10 can be composed of, for example, a laminate sheet made of aluminum whose both surfaces are covered with a resin layer.

(Electrolyte)

The electrolyte is interposed between the first electrode 11 and the second electrode 12. Specifically, the separator interposed between the first polarizable electrode 11b of the first electrode 11 and the second polarizable electrode 12b of the second electrode 12 is impregnated with the electrolyte.

The electrolyte includes a cation, an anion, and a solvent. Preferably used cations include, for example, tetraethylammonium salts. Preferably used anions include, for example, tetrafluoroborate ions (BF₄⁻) and bistrifluoromethylsulfonylimide ((CF₃SO₂)₂N⁻). Preferably used solvents include carbonate compounds such as propylene carbonate, ethylene carbonate, diethyl carbonate, dimethyl carbonate, nitrile compounds, and aqueous solvents such as water.

The electrolyte may be, for example, a crosslinkable gel electrolyte or an ionic liquid composed of an imidazole compound.

(Bonding Part 14)

As shown in FIG. 1 and FIG. 3, the separator 13 is provided with a bonding part 14 filled with a resin. The bonding part 14 extends to a surface of the separator 13 closer to the first polarizable electrode 11b. The separator 13 and the first polarizable electrode 11b are bonded to each other by the bonding part 14. According to the present embodiment, the separator 13 and the first polarizable electrode 11b make contact with each other in the region provided with the bonding part 14. For this reason, it is not always necessary to provide a bonding layer between the separator 13 and the first polarizable electrode 11b. More specifically, the separator 13 can be attached to the first polarizable electrode 11b without providing any bonding layer. Therefore, the gap can be reduced between the separator 13 and the first polarizable electrode 11b. As a result, the gap can be reduced between the first electrode 11 and the second electrode 12. Therefore, the thickness of the electric double layer capacitor 1 can be reduced.

From the viewpoint of further reducing the thickness of the electric double layer capacitor 1, as shown in FIG. 3, it is preferable for the bonding part 14 to also extend to the surface closer to the second polarizable electrode 12b, and for the bonding part 14 to connect the separator 13 and the second polarizable electrode 12b to each other. In this case, it is not always necessary to provide a bonding layer between the separator 13 and the second polarizable electrode 12b. More specifically, the separator 13 can be attached to the second polarizable electrode 12b without providing any bonding layer. Therefore, the gap can be made smaller between the first polarizable electrode 11b and the second polarizable electrode 12b. Therefore, the thickness of the electric double layer capacitor 1 can be further reduced.

From the same viewpoint, in the electric double layer capacitor 1, the entire surface of the separator 13 closer to the first polarizable electrode preferably makes contact with the first polarizable electrode 11b.

Now, from the viewpoint of firmly bonding the first electrode 11 and the separator 13, the bonding part 14 is believed to be preferably provided so as to extend to the first collector electrode 11a. However, as a result of earnest researches made by the inventors, it has been found that the electric characteristics of the electric double layer capacitor deteriorate when the bonding part is provided so as to extend to the collector electrode. From the viewpoint of suppressing the deterioration of electric characteristics of the electric double layer capacitor, the bonding portion 14 preferably does not extend to the first collector electrode 11a. In this case, the flow of the electrolyte in the first polarizable electrode 11b, and of the gas generated in the electric double layer capacitor 1 can be prevented from being blocked and interrupted by the bonding part 14. For this reason, the internal resistance in the electric double layer capacitor 1 can be prevented from being increased.

The bonding part 14 may be provided at the opposed part 11A or in the non-opposed part 11C.

When the bonding part 14 is provided at the opposed part 11A, the gap between the first electrode 11 and the second electrode 12 can be prevented in a more effective manner from being increased at the opposed part 11A which functions as a capacitor. Therefore, the decrease in capacitance and the increase in internal resistance can be suppressed.

From the viewpoint of further effectively preventing the gap between the first electrode 11 and the second electrode 12 from being increased, the bonding part 14 is preferably provided so as to have an overlap with a central part of the opposed part 11A as viewed from the thickness direction.

In addition, from the viewpoint of preventing the gap between the first electrode 11 and the second electrode 12 from being increased, the first electrode 11 and the second electrode 12 are preferably fixed at both one side and the other side in the x-axis direction which is a longitudinal direction. According to the present embodiment, the plurality of extended parts 11B positioned on the x1 side in the x-axis direction is fixed, and the plurality of extended parts 12B is fixed. For this reason, as shown in FIG. 2, the bonding part 14 is preferably provided such that at least a part of the bonding part 14 has an overlap with a region A (a hatched region in FIG. 2) located on the x2 side in the x-axis direction with respect to the center of the opposed part 11A in the x-axis direction. Furthermore, in the present embodiment in which the extended part 11B is provided on the y1 side in the y-axis direction, whereas the extended part 12B is provided on the y2 side in the y-axis direction, the bonding portion 14 is preferably provided such that a part of the bonding part 14 has an overlap with a center line L extending in the x-axis direction through the center of the opposed part 11A in the y-axis direction.

The area of the bonding part 14 is not particularly limited as long as it is enough to fix the separator 13 and the electrodes 11, 12 with sufficient strength. From the viewpoint of firmly bonding the separator 13 and the electrodes 11, 12, the proportion of the area occupied by the bonding part 14 is preferably 1% or higher, more preferably 2% or higher, and further preferably 3% or higher at a part of the separator 13 opposed to the first polarizable electrode 11b. However, if the proportion of the area occupied by the bonding part 14 is excessively high at the part of the separator 13 opposed to the first polarizable electrode 11b, the capacitance of the electric double layer capacitor 1 may be decreased in some cases. Therefore, the proportion of the area occupied by the bonding part 14 is preferably 30% or lower, more preferably 20% or lower, and further preferably 10% or lower at the part of the separator 13 opposed to the first polarizable electrode 11b.

The adhesive for use in the formation of the bonding part 14 is not particularly limited, but it is preferable to use a resin adhesive that is low in adhesiveness, electrolytic solution resistance, moisture resistance, or viscosity in a liquid state as a simple substance, or in an adjusted solution or dispersion state.

Specific examples of preferably used resin adhesives include, for example, polytetrafluoroethylene, polyvinylidene fluoride, crosslinked fluoroolefin copolymer, polyvinyl alcohol, epoxy resins, silicone resins, acrylic resins, acrylic acid esters, methacrylic acid esters, polypropylene, polyethylene, ionomer, styrene butadiene rubbers, polyimide, polyamide imide, urethane, and polyphenylene sulfide.

It is to be noted that an example in which the bonding part 14 is provided for each of the separators 13 has been described in the present embodiment. However, the present invention is not limited to this configuration. For example, each separator may be provided with a plurality of bonding parts.

(Method for Manufacturing Electric Double Layer Capacitor 1)

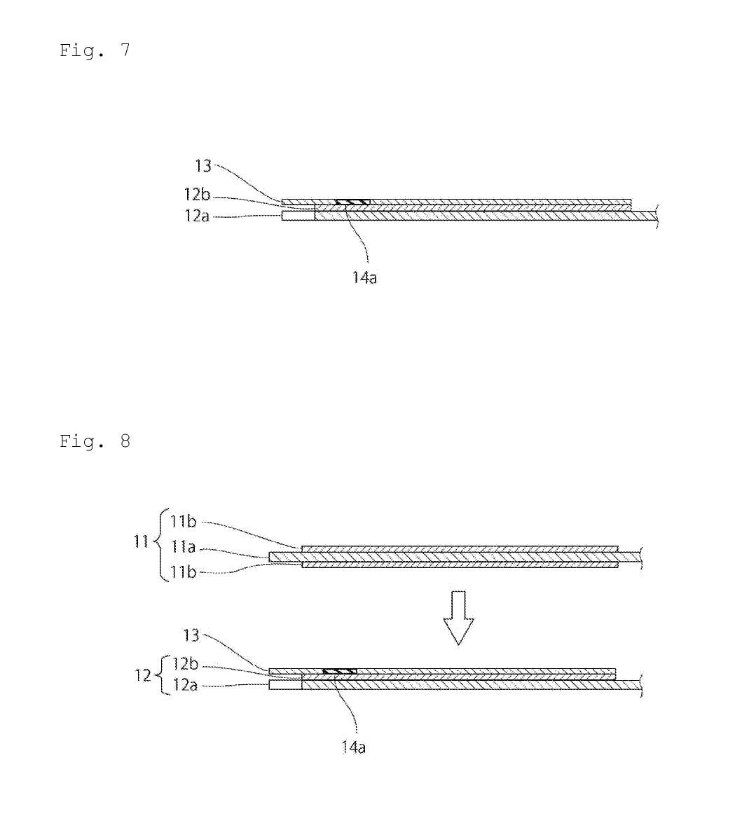

FIGS. 6 to 11 are schematic cross-sectional views illustrating a process for manufacturing the electric double layer capacitor 1 according to the present embodiment. An example of a method for manufacturing the electric double layer capacitor 1 according to the present embodiment will be described below with reference to FIGS. 6 to 11.

As shown in FIG. 6, the first or second polarizable electrode 11b, 12b is formed on the first or second collector electrode 11a, 12a. The polarizable electrodes 11b, 12b can be formed by, for example, screen printing or the like.

Next, the separator 13 is stacked on the first or second polarizable electrode 11b, 12b. Thereafter, as shown in FIG. 7, a resin (adhesive) is applied from above the separator 13 to impregnate the separator 13 with the adhesive including the resin, thereby forming an adhesive impregnated part 14a. Specifically, the separator 13 is impregnated with the adhesive including the resin, with the separator 13 and the first or second polarizable electrode 11b, 12b in close contact with each other.

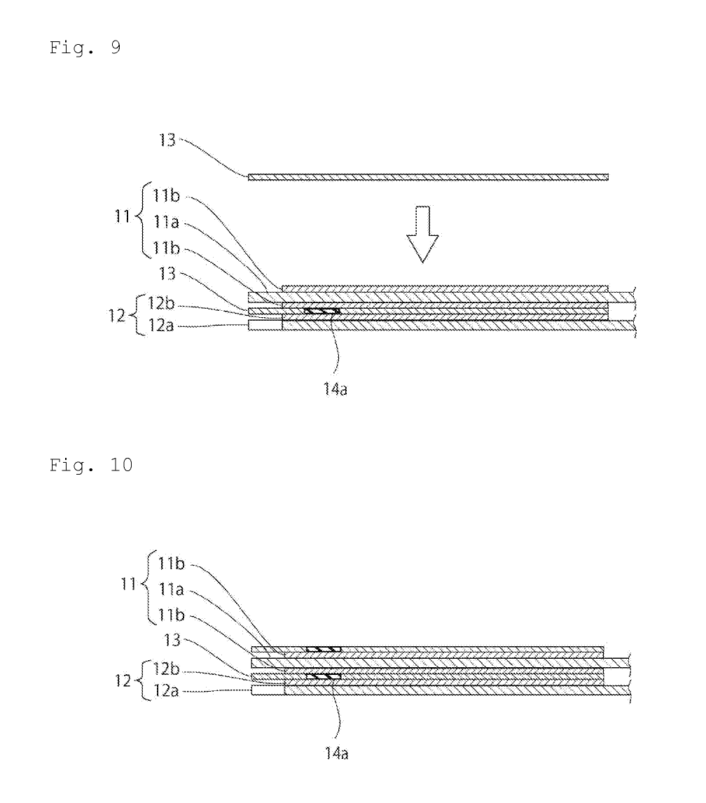

Next, as shown in FIG. 8, the first or second collector electrode 11a, 12a with the first or first polarizable electrode 11b, 12b formed on both surfaces of the collector electrode is stacked on the separator 13.

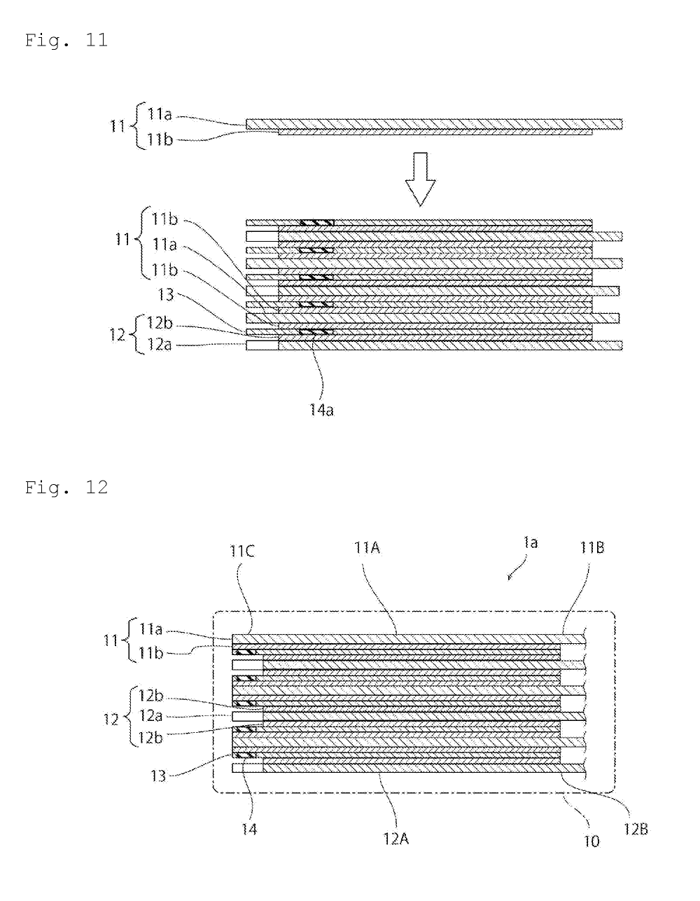

Next, as shown in FIG. 9, the separator 13 is stacked on the first or second polarizable electrode 11b, 12b. Thereafter, as shown in FIG. 10, the separator 13 is impregnated with the adhesive including the resin, thereby forming an adhesive impregnated portion 14a.

The foregoing steps are repeated, and as shown in FIG. 11, the first or second collector electrode 11a, 12a with the first or second polarizable electrode 11b, 12b formed on one surface of the collector electrode is stacked on the separator 13, thereby preparing a laminated body.

The prepared laminated body is pressed and thermocompression-bonded to form the bonding part 14 from the adhesive impregnated part 14a. Next, the laminate is put in an exterior body. Thereafter, the electric double layer capacitor 1 can be fabricated by injecting an electrolyte into the exterior body and sealing the exterior pair.

As described above, the formation of the bonding part 14 through the impregnation with the resin, with the polarizable electrodes 11b, 12b and the separator 13 stacked on one another, makes it possible to manufacture an electric double layer capacitor with the electrodes 11, 12 and the separators in contact with each other in the region provided with the bonding part 14.

It is to be noted that examples of the adhesive including the resin (resin adhesive) include, for example, an adhesive including a monomer, an oligomer, or the like for a resin that is cured by polymerization.

Other examples of preferred embodiments of the present invention will be described below. In the following description, members that have substantially the same functions as those in the first embodiment will be referred to with common reference numerals, and description thereof will be omitted.

### Second Embodiment

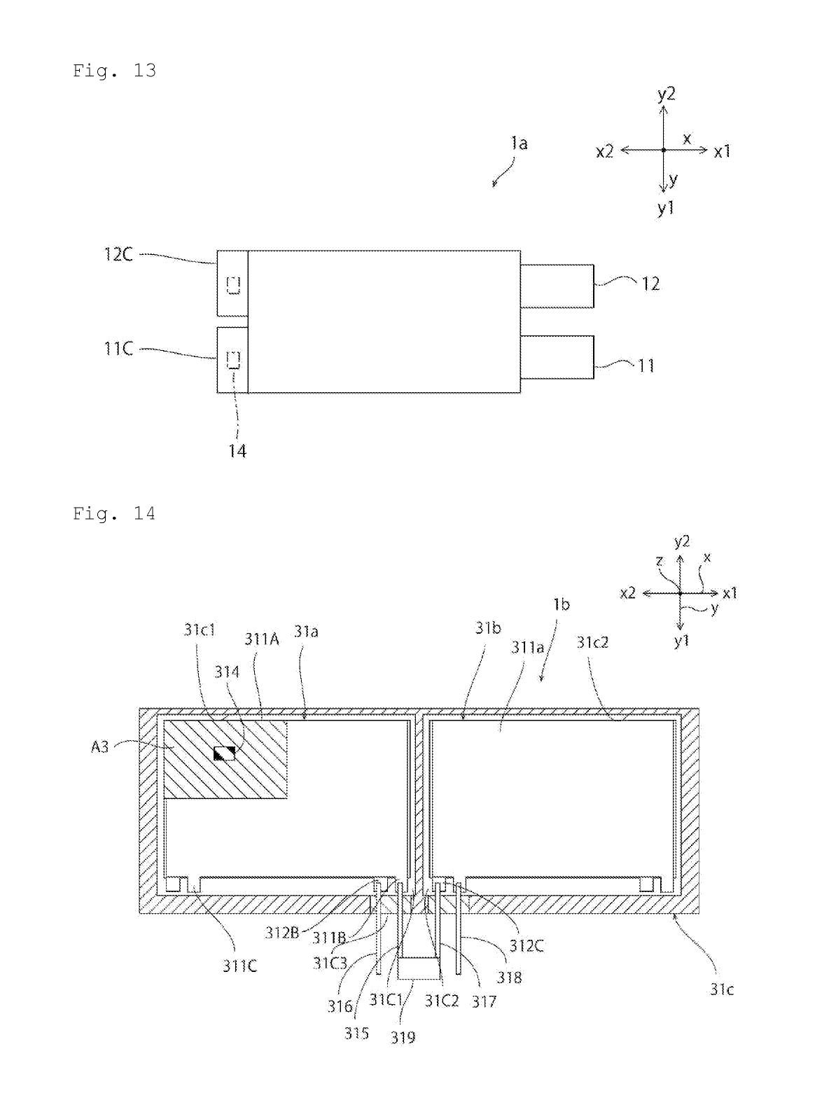

FIG. 12 is a schematic cross-sectional view of an electric double layer capacitor 1a according to the second embodiment. FIG. 13 is a schematic plan view of the main part of the electric double layer capacitor 1a according to the second embodiment. In FIG. 13, the illustration of an exterior body 10 and the separator 13 is omitted.

In the first embodiment, an example in which the bonding part 14 is provided at the opposed part as viewed from the thickness direction has been described. However, the present invention is not limited thereto.

According to the second embodiment, a bonding part is provided at non-opposed parts 11C and 12C. In this case, it is not always necessary to provide the bonding part 14 at the opposed part 11A, the effective area of the opposed part 11A is thus not decreased. Therefore, the decrease in the capacitance of the electric double layer capacitor 1, and the decrease in ESR can be prevented from being caused.

### Third Embodiment

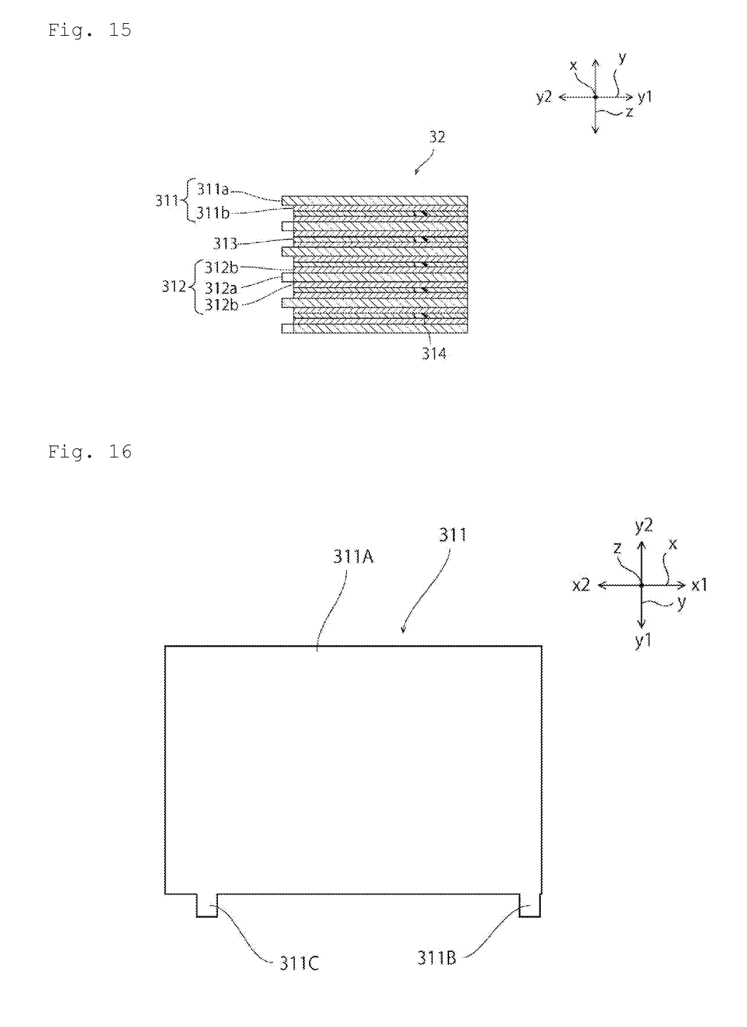

FIG. 14 is a schematic plan view of an electric double layer capacitor 1b according to the present embodiment.

According to the present embodiment, the electric double layer capacitor 1b includes a first electric double layer capacitor element 31a and a second electric double layer capacitor element 31b enclosed in a package 31c. Each of the first and second electric double layer capacitor elements 31a and 31b has a rectangular shape whose longitudinal direction is parallel to the x-axis direction (second direction). The first electric double layer capacitor element 31a and the second electric double layer capacitor element 31b are arranged in the x-axis direction. For this reason, the package 31c also has a rectangular shape whose longitudinal direction is parallel to the x-axis direction.

The package 31c is provided with a rectangular first cell 31c1 and a rectangular second cell 31c2 adjacent to the first cell 31c1 in the x-axis direction. The first electric double layer capacitor element 31a is sealed in the first cell 31c1. The second electric double layer capacitor element 31b is sealed in the second cell 31c2.

Each cell 31c1, 31c2 is filled with an electrolytic solution. The electrolytic solution includes a cation, an anion, and a solvent. Preferably used cations include, for example, tetraethylammonium salts. Preferably used anions include, for example, tetrafluoroborate ions (BF₄⁻) and bistrifluoromethylsulfonylimide ((CF₃SO₂)₂N⁻). Preferably used solvents include carbonate compounds such as propylene carbonate, ethylene carbonate, diethyl carbonate, dimethyl carbonate, nitrile compounds, and aqueous solvents such as water.

The electrolytic solution may be, for example, a crosslinkable gel electrolytic solution or an ionic liquid composed of an imidazole compound.

According to the present embodiment, the first electric double layer capacitor element 31a and the second electric double layer capacitor element 31b are composed of the same electric double layer capacitor element 32.

FIG. 15 shows a schematic cross-sectional view of a main part of the electric double layer capacitor element 32. As shown in FIG. 15, the electric double layer capacitor element 32 includes a first electrode 311, a second electrode 312, and a separator 313.

The first electrode 311 and the second electrode 312 are opposed to each other with the separator 313 interposed therebetween. Specifically, a plurality of first electrodes 311 and a plurality of second electrodes 312 are alternately stacked with separators 313 interposed therebetween.

The first electrode 311 includes a first collector electrode 311a. The first collector electrode 311a can be made of, for example, aluminum foil or the like. The thickness of the first collector electrode 311a can be, for example, about 10 μm or more and 30 μm or less. On the first collector electrode 311a, a first polarizable electrode 311b is provided. Specifically, the first polarizable electrode 311b is provided, among the principal surfaces of the first collector electrodes 311a, only on the principal surfaces opposed to the second electrodes 312. The thickness of the first polarizable electrode 311b can be, for example, about 10 μm or more and 30 μm or less. The first polarizable electrode 311b can be made of, for example, carbon or the like.

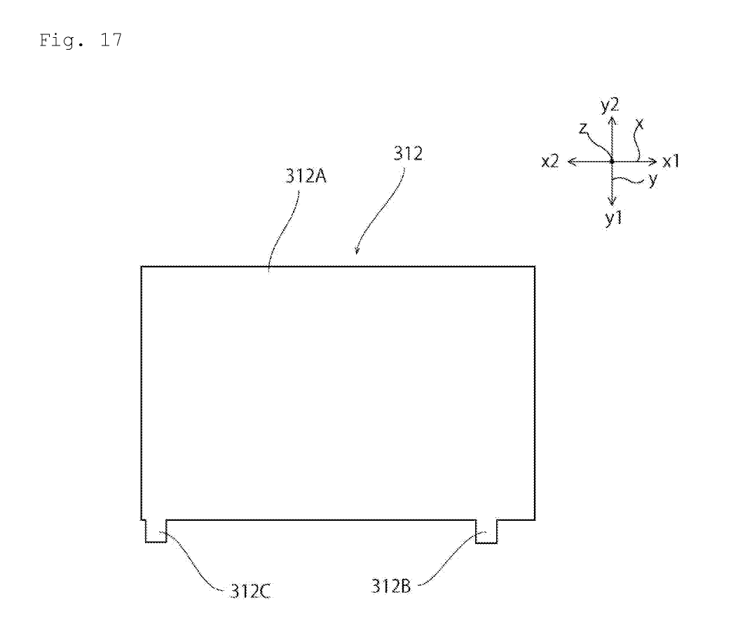

As shown in FIG. 16, the first electrode 311 has a rectangular first electrode main body (opposed part) 311A. The first electrode main body 311A is opposed to the second electrode 312 with the separator 313 interposed therebetween. From the corner on the x1 side of the first electrode main body 311A in the x-axis direction (first direction) and on the y1 side thereof in the y-axis direction (first direction), a rectangular extended part 311B is connected which extends toward the y1 side. On the other hand, a rectangular extended part 311C extending toward the y1 side is connected from the corner on the x2 side of the first electrode main body 311A in the x axis direction and on the y1 side thereof in the y-axis direction.

The second electrode 312 shown in FIGS. 14 and 15 has a second collector electrode 312a. The second collector electrode 312a can be made of, for example, aluminum foil or the like. The thickness of the second collector electrode 312a can be, for example, about 10 μm or more and 30 μm or less.

On the second collector electrode 312a, a second polarizable electrode 312b is provided. Specifically, the second polarizable electrode 312b is provided, among the principal surfaces of the second collector electrodes 312a, only on the principal surfaces opposed to the first electrodes 311. The thickness of the second polarizable electrode 312b can be, for example, about 10 μm or more and 30 μm or less. The second polarizable electrode 312b can be made of, for example, carbon or the like.

As shown in FIG. 17, the second electrode 312 has a rectangular second electrode main body (opposed part) 312A. The second electrode main body 312A is opposed to the first electrode 311 with the separator 313 interposed therebetween. From the corner on the x1 side of the second electrode main body 312A in the x-axis direction and on the y1 side thereof in the y-axis direction, a rectangular extended part 312B is connected which extends toward the y1 side. On the other hand, a rectangular extended part 312C extending toward the y1 side is connected from the corner on the x2 side of the second electrode main body 312A in the x axis direction and on the y1 side thereof in the y-axis direction.

The first electrode 311 and the second electrode 312 adjacent to each other in the z-axis direction (thickness direction) are bonded to each other with a bonding part 314.

As shown in FIG. 15, the separator 313 is provided between the first electrode 311 and the second electrode 312 adjacent to each other. The separator 313 has substantially the same shape as the first electrode 311 and the second electrode 312, or has a larger flat plate shape than the first electrode 311 and the second electrode 312. The separator 313 separates the first electrode 311 and the second electrode 312 from each other. The separator 313 can be composed of, for example, a porous sheet with a plurality of open cells. The separator 313 is impregnated with an electrolytic solution.

As shown in FIG. 14, in the first electric double layer capacitor element 31a, the extended part 311B of the first electrode 311 and the extended part 312B of the second electrode 312 are positioned at the first corner 31C1. The extended part 312B is positioned more outside (x2 side) in the x-axis direction than the extended part 311B. The extended part 311C of the first electrode 311 and the extended part 312C of the second electrode 312 are positioned at the second corner 31C2. The extended part 311C is positioned more inside (x1 side) in the x-axis direction than the extended part 312C. The extended parts 311B, 312B are each integrally fixed.

In the second electric double layer capacitor element 31b, the extended part 311C of the first electrode 311 and the extended part 312C of the second electrode 312 are positioned at the second corner 31C2. The extended part 311C is positioned more outside (x1 side) in the x-axis direction than the extended part 312C. The extended part 311B of the first electrode 311 and the extended part 312B of the second electrode 312 are positioned at the first corner 31C1. The extended part 312B is positioned more inside (x2 side) in the x-axis direction than the extended part 311B. The extended parts 311C, 312C are each integrally fixed.

The first electric double layer capacitor element 31a has a first electrode terminal 315 connected to the extended part 311B of the first electrode 311 at the first corner 31C1 of the first cell 31c1. The first electrode terminal 315 extends from the extended part 311B toward the y1 side in the y-axis direction. The first electrode terminal 315 penetrates a sealing part 31C3 of the package 31c to be extended even to the outside of the first cell 31c1.

The first electric double layer capacitor element 31a has a second electrode terminal 316 connected to the extended part 312B of the second electrode 312 at the first corner 31C1 of the first cell 31c1. The second electrode terminal 316 extends from the extended part 312B toward the y1 side in the y-axis direction. The second electrode terminal 316 penetrates a sealing part 31C3 of the package 31c to be extended even to the outside of the first cell 31c1.

The second electric double layer capacitor element 31b has a second electrode terminal 317 connected to the extended part 312C of the second electrode 312 at the second corner 31C2 of the second cell 31c2. The second electrode terminal 317 extends from the extended part 312C toward the y1 side in the y-axis direction. The second electrode terminal 317 penetrates a sealing part 31C3 of the package 31c to be extended even to the outside of the first cell 31c1. The second electrode terminal 317 and the first electrode terminal 315 are electrically connected by a connecting material 319.

The second electric double layer capacitor element 31b has a first electrode terminal 318 extending from the extended part 311C of the first electrode 311 toward the y1 side in the y axis direction at the second corner 31C2 of the second cell 31c2. The first electrode terminal 318 penetrates a sealing part 31C3 of the package 31c to be extended even to the outside of the first cell 31c1.

As shown in FIG. 15, the separator 313 is provided with a bonding part 314 filled with a resin. The bonding part 314 extends to a surface of the separator 313 closer to the first polarizable electrode 311b. The separator 313 and the first polarizable electrode 311b are bonded to each other by the bonding part 314. Specifically, according to the present embodiment, the separator 313 and the first polarizable electrode 311b make contact with each other in the region provided with the bonding part 314. For this reason, it is not always necessary to provide a bonding layer between the separator 313 and the first polarizable electrode 311b. Therefore, the thickness of the electric double layer capacitor 1b can be reduced.

As described above, according to the present embodiment, in the first cell 31c1, the multiple extended parts 311B and 312B stacked in the thickness direction are each fixed and integrated. The extended parts 311B, 312B are extended from the parts, on the x1 side of the rectangular opposed part 311A which is a part of the first electrode 311 opposed to the second electrode 312 in the x-axis direction (the direction along the long side of the opposed part 311A), and on the y1 side in the y-axis direction (the direction along the short side of the opposed part 311A). In this case, as shown in FIG. 14, the bonding part 314 is preferably provided such that at least a part of the bonding part 314 has an overlap with a region located on the x2 side with respect to the center of the opposed part 311A in the x-axis direction (second direction).

Alternatively, the bonding part 314 is preferably provided such that at least a part of the bonding part 314 has an overlap with a region located on the y2 side with respect to the center of the opposed part 311A in the y-axis direction (first direction). In this case, the electrodes 311, 312 and the separators 313 can be fixed at a plurality of spaced-apart sites. Therefore, the gap can be reduced between the electrode 311 and the electrode 312. Therefore, the capacitance of the electric double layer capacitor 1b can be increased. In addition, the internal resistance of the electric double layer capacitor 1b can be reduced.

From the same point of view, the bonding part 314 is preferably provided such that at least a part thereof has an overlap with a part on the y2 side with respect to the center in the y-axis direction (first direction) and on the x2 side with respect to the center in the x-axis direction (second direction).

The adhesive for use in the formation of the bonding part 314 is not particularly limited, but it is preferable to use a resin adhesive that is low in adhesiveness, electrolytic solution resistance, moisture resistance, or viscosity in a liquid state as a simple substance, or in an adjusted solution or dispersion state.

Specific examples of preferably used resin adhesives include, for example, polytetrafluoroethylene, polyvinylidene fluoride, crosslinked fluoroolefin copolymer, polyvinyl alcohol, epoxy resins, silicone resins, acrylic resins, acrylic acid esters, methacrylic acid esters, polypropylene, polyethylene, ionomer, styrene butadiene rubbers, polyimide, polyamide imide, urethane, and polyphenylene sulfide.

It is to be noted that an example in which the opposed part 311A and the separator 313 are bonded by the bonding part 314 has been described in the present embodiment, but the non-opposed part of the first electrode 311 and the separator 313 may be bonded by the bonding part 314.

In the present embodiment, an example in which the bonding part 14 is provided for each of the separators 13 has been described. However, the present invention is not limited to this configuration. For example, each separator may be provided with a plurality of bonding parts.

It is to be noted that the electric double layer capacitor 1b according to the present embodiment can be manufactured, for example, by the same manufacturing method as the method for manufacturing the electric double layer capacitor 1 according to the first embodiment.

### DESCRIPTION OF REFERENCE SYMBOLS

1, 1a, 1b: electric double layer capacitor
10: exterior body
11, 311: first electrode
12, 312: second electrode
11A, 12A: opposed part
11A1: first side
11A2: second side
11A3: third side
11A4: fourth side
11B, 12B, 311B, 311C, 312B, 312C: extended part
11C, 12C: non-opposed part
11a, 311a: first collector electrode
12a, 312a: second collector electrode
11b, 311b: first polarizable electrode
12b, 312b: second polarizable electrode
13, 313: separator
14, 314: bonding part
14a: adhesive impregnated part
31C1: first corner
31C2: second corner
31C3: sealing part
31a: first electric double layer capacitor element
31b: second electric double layer capacitor element
31c: package
31c1: first cell
31c2: second cell
32: electric double layer capacitor element
311A: first electrode main body (opposed part)
312A: second electrode main body (opposed part)
315, 318: first electrode terminal
316, 317: second electrode terminal
319: connecting material

1. An electric double layer capacitor comprising:
a first electrode comprising a first collector electrode and a first polarizable electrode on the first collector electrode;
a second electrode comprising a second collector electrode and a second polarizable electrode on the second collector electrode, the second electrode opposed to the first electrode; and
a separator impregnated with an electrolyte and interposed between the first polarizable electrode and the second polarizable electrode,
wherein
the separator includes a bonding part filled with a resin,
the bonding part extends to a first surface of the separator closer to the first polarizable electrode, and the separator and the first polarizable electrode are bonded to each other by the bonding part.

2. The electric double layer capacitor according to claim 1, wherein the separator and the first polarizable electrode contact each other in a region provided with the bonding part.

3. The electric double layer capacitor according to claim 1, wherein the bonding part extends to a second surface of the separator closer to the second polarizable electrode, and the separator and the second polarizable electrode are bonded to each other by the bonding part.

4. The electric double layer capacitor according to claim 1, wherein an entirety of the first surface of the separator closer to the first polarizable electrode contacts the first polarizable electrode.

5. The electric double layer capacitor according to claim 1, wherein the bonding part does not extend to the first collector electrode.

6. The electric double layer capacitor according to claim 1, wherein
the first electrode includes an opposed part that is opposed to the second electrode in a thickness direction of the electric double layer capacitor, and a non-opposed part that is not opposed to the second electrode in the thickness direction, and the bonding part bonds the non-opposed part and the separator to each other.

7. The electric double layer capacitor according to claim 1, wherein
the first electrode includes an opposed part that is opposed to the second electrode in a thickness direction of the electric double layer capacitor, and a non-opposed part that is not opposed to the second electrode in the thickness direction, and the bonding part overlaps with a central part of the opposed part.

8. The electric double layer capacitor according to claim 1, wherein
the first electrode has an opposed part that is opposed to the second electrode in the thickness direction of the electric double layer capacitor, and an extended part that is extended from the opposed part,
the opposed part has a rectangular shape with first and second sides extending in a first direction and third and fourth sides extending in a second direction perpendicular to the first direction,
the extended part extends in the second direction from the opposed part and is positioned on one side of a center line of the opposed part in the second direction, and
as viewed from the thickness direction, at least a part of the bonding part is on one side of the center line of the opposed part in the second direction.

9. The electric double layer capacitor according to claim 8, wherein
as viewed from the thickness direction, at least a part of the bonding part is on one side of a center line of the opposed part in the first direction.

10. The electric double layer capacitor according to claim 8, wherein, as viewed from the thickness direction, the bonding part overlaps the center line of the opposed part in the second direction.

11. A method for manufacturing an electric double layer capacitor, the method comprising:
stacking a separator impregnated with an electrolyte on a first polarizable electrode of a first electrode;
forming a bonding part by impregnating the separator with an adhesive comprising a resin, the bonding part extending to a first surface of the separator closer to the first polarizable electrode;
stacking a second polarizable electrode of a second electrode on the separator; and
bonding the separator and the first polarizable electrode to each other by the bonding part.

12. The method of manufacturing the electric double layer capacitor according to claim 11, wherein the separator and the first polarizable electrode contact each other in a region provided with the bonding part.

13. The method of manufacturing the electric double layer capacitor according to claim 11, wherein the bonding part is formed so as to extend to a second surface of the separator closer to the second polarizable electrode, and the separator and the second polarizable electrode are bonded to each other by the bonding part.

14. The method of manufacturing the electric double layer capacitor according to claim 11, wherein an entirety of the first surface of the separator closer to the first polarizable electrode contacts the first polarizable electrode.

15. The method of manufacturing the electric double layer capacitor according to claim 11, wherein the bonding part is formed so as to not extend to the first collector electrode.

16. The method of manufacturing the electric double layer capacitor according to claim 11, wherein
the first electrode includes an opposed part that is opposed to the second electrode in a thickness direction of the electric double layer capacitor, and a non-opposed part that is not opposed to the second electrode in the thickness direction, and the bonding part bonds the non-opposed part and the separator to each other.

17. The method of manufacturing the electric double layer capacitor according to claim 11, wherein
the first electrode includes an opposed part that is opposed to the second electrode in a thickness direction of the electric double layer capacitor, and a non-opposed part that is not opposed to the second electrode in the thickness direction, and the bonding part overlaps with a central part of the opposed part.

18. The method of manufacturing the electric double layer capacitor according to claim 11, wherein
the first electrode has an opposed part that is opposed to the second electrode in the thickness direction of the electric double layer capacitor, and an extended part that is extended from the opposed part,
the opposed part has a rectangular shape with first and second sides extending in a first direction and third and fourth sides extending in a second direction perpendicular to the first direction,
the extended part extends in the second direction from the opposed part and is positioned on one side of a center line of the opposed part in the second direction, and
as viewed from the thickness direction, at least a part of the bonding part is on one side of the center line of the opposed part in the second direction.

19. The method of manufacturing the electric double layer capacitor according to claim 18, wherein
as viewed from the thickness direction, at least a part of the bonding part is on one side of a center line of the opposed part in the first direction.

20. The method of manufacturing the electric double layer capacitor according to claim 18, wherein, as viewed from the thickness direction, the bonding part overlaps the center line of the opposed part in the second direction.
